(19) United States
(12) Patent Application Publication
(10) Pub. No.: US 2015/0352658 A1
(43) Pub. Date: Dec. 10, 2015

(54) INTRUDING FEATURE IN ALUMINUM ALLOY WORKPIECE TO IMPROVE AL-STEEL SPOT WELDING

(71) Applicant: GM GLOBAL TECHNOLOGY OPERATIONS LLC, DETROIT, MI (US)

(72) Inventors: David Yang, Shanghai (CN); David R. Sigler, Shelby Township, MI (US); Hui-Ping Wang, Troy, MI (US)

(21) Appl. No.: 14/729,693

(22) Filed: Jun. 3, 2015

Related U.S. Application Data
(60) Provisional application No. 62/010,192, filed on Jun. 10, 2014.

(51) Int. Cl. B23K 11/11; B23K 11/20

(52) U.S. Cl. CPC B23K 11/115; B23K 11/20

(57) ABSTRACT

A method of spot welding a workpiece stack-up that includes a steel workpiece and an adjacent aluminum alloy workpiece involves passing an electrical current through the workpiece stack-up and between facially aligned welding electrodes in contact with opposed sides of the stack-up. The formation of a weld joint between the adjacent steel and aluminum alloy workpieces is aided by an intruding feature located in an aluminum alloy workpiece that provides and delineates one side of the workpiece stack-up and against which a welding electrode is pressed over the intruding feature at the weld site. The intruding feature affects the flow pattern and density of the electrical current that passes through the overlapping workpieces and is also believed to help minimize the effects of any refractory surface oxide layer(s) that may be present on the aluminum alloy workpiece that lies adjacent to the steel workpiece.

### CROSS-REFERENCE TO RELATED APPLICATION

This application claims the benefit of U.S. Provisional Application No. 62/010,192, filed on Jun. 10, 2014, the entire contents of which are hereby incorporated by reference.

### TECHNICAL FIELD

The technical field of this disclosure relates generally to resistance spot welding and, more particularly, to resistance spot welding a steel workpiece and an aluminum alloy workpiece.

### BACKGROUND

Resistance spot welding is a process used by a number of industries to join together two or more metal workpieces. The automotive industry, for example, often uses resistance spot welding to join together pre-fabricated metal workpieces during the manufacture of a vehicle door, hood, trunk lid, or lift gate, among others. A number of spot welds are typically formed along a peripheral edge of the metal workpieces or some other bonding region to ensure the part is structurally sound. While spot welding has typically been practiced to join together certain similarly-composed metal workpieces—such as steel-to-steel and aluminum alloy-to-aluminum alloy—the desire to incorporate lighter weight materials into a vehicle body structure has generated interest in joining steel workpieces to aluminum alloy workpieces by resistance spot welding. The aforementioned desire to resistance spot weld dissimilar metal workpieces is not unique to the automotive industry; indeed, it extends other industries that may utilize spot welding as a joining process including the aviation, maritime, railway, and building construction industries, among others.

Resistance spot welding, in general, relies on the resistance to the flow of an electrical current through overlapping metal workpieces and across their faying interface(s) to generate heat. To carry out such a welding process, a set of two opposed spot welding electrodes is clamped at aligned spots on opposite sides of the workpiece stack-up, which typically includes two or three metal workpieces arranged in lapped configuration, at a predetermined weld site. An electrical current is then passed through the metal workpieces from one welding electrode to the other. Resistance to the flow of this electrical current generates heat within the metal workpieces and at their faying interface(s). When the workpiece stack-up includes a steel workpiece and an adjacent aluminum alloy workpiece, the heat generated at the faying interface and within the bulk material of those dissimilar metal workpieces initiates and grows a molten aluminum alloy weld pool that extends into the aluminum alloy workpiece from the faying interface. This molten aluminum alloy weld pool wets the adjacent faying surface of the steel workpiece and, upon cessation of the current flow, solidifies into a weld nugget that forms all or part of a weld joint that bonds the two workpieces together.

In practice, however, spot welding a steel workpiece to an aluminum alloy workpiece is challenging since a number of characteristics of those two metals can adversely affect the strength—most notably the peel strength—of the weld joint. For one, the aluminum alloy workpiece usually contains one or more mechanically tough, electrically insulating, and self-healing refractory oxide layers on its surface. The oxide layer(s) are typically comprised of aluminum oxides, but may include other metal oxide compounds as well, including magnesium oxides when the aluminum alloy workpiece is composed of a magnesium-containing aluminum alloy. As a result of their physical properties, the refractory oxide layer(s) have a tendency to remain intact at the faying interface where they can hinder the ability of the molten aluminum alloy weld pool to wet the steel workpiece and also provide a source of near-interface defects within the growing weld pool. The insulating nature of the surface oxide layer(s) also raises the electrical contact resistance of the aluminum alloy workpiece—namely, at its faying surface and at its electrode contact point—making it difficult to effectively control and concentrate heat within the aluminum alloy workpiece. Efforts have been made in the past to remove the oxide layer(s) from the aluminum alloy workpiece prior to spot welding. Such removal practices can be impractical, though, since the oxide layer(s) have the ability to regenerate in the presence of oxygen, especially with the application of heat from spot welding operations.

The steel workpiece and the aluminum alloy workpiece also possess different properties that tend to complicate the spot welding process. Specifically, steel has a relatively high melting point (˜1500° C.) and relatively high electrical and thermal resistivities, while the aluminum alloy material has a relatively low melting point (˜600° C.) and relatively low electrical and thermal resistivities. As a result of these physical differences, most of the heat is generated in the steel workpiece during current flow. This heat imbalance sets up a temperature gradient between the steel workpiece (higher temperature) and the aluminum alloy workpiece (lower temperature) that initiates rapid melting of the aluminum alloy workpiece. The combination of the temperature gradient created during current flow and the high thermal conductivity of the aluminum alloy workpiece means that, immediately after the electrical current ceases, a situation occurs where heat is not disseminated symmetrically from the weld site. Instead, heat is conducted from the hotter steel workpiece through the aluminum alloy workpiece towards the welding electrode on the other side of the aluminum alloy workpiece, which creates a steep thermal gradient between the steel workpiece and that particular welding electrode.

The development of a steep thermal gradient between the steel workpiece and the welding electrode on the other side of the aluminum alloy workpiece is believed to weaken the integrity of the resultant weld joint in two primary ways. First, because the steel workpiece retains heat for a longer duration than the aluminum alloy workpiece after the flow of electrical current has ceased, the molten aluminum alloy weld pool solidifies directionally, starting from the region nearest the colder welding electrode (often water cooled) associated with the aluminum alloy workpiece and propagating towards the faying interface. A solidification front of this kind tends to sweep or drive defects—such as gas porosity, shrinkage voids, micro-cracking, and surface oxide residue—towards and along the faying interface within the weld nugget. Second, the sustained elevated temperature in the steel workpiece promotes the growth of brittle Fe—Al intermetallic compounds at and along the faying interface. The intermetallic compounds tend to form thin reaction layers between the weld nugget and the steel workpiece. These intermetallic layers, if present, are generally considered part of the weld joint in addition to the weld nugget. Having a dispersion of weld nugget defects together with excessive growth of Fe—Al intermetallic compounds along the faying interface tends to reduce the peel strength of the final weld joint.

In light of the aforementioned challenges, previous efforts to spot weld a steel workpiece and an aluminum-based workpiece have employed a weld schedule that specifies higher currents, longer weld times, or both (as compared to spot welding steel-to-steel), in order to try and obtain a reasonable weld bond area. Such efforts have been largely unsuccessful in a manufacturing setting and have a tendency to damage the welding electrodes. Given that previous spot welding efforts have not been particularly successful, mechanical fasteners such as self-piercing rivets and flow-drill screws have predominantly been used instead. Such mechanical fasteners, however, take longer to put in place and have high consumable costs compared to spot welding. They also add weight to the vehicle body structure—weight that is avoided when joining is accomplished by way of spot welding—that offsets some of the weight savings attained through the use of aluminum alloy workpieces in the first place. Advancements in spot welding that would make the process more capable of joining steel and aluminum alloy workpieces would thus be a welcome addition to the art.

### SUMMARY OF THE DISCLOSURE

A method of resistance spot welding a workpiece stack-up that includes at least a steel workpiece and an adjacent aluminum alloy workpiece is disclosed. The workpiece stack-up may also include an additional workpiece such as another steel workpiece or another aluminum alloy workpiece so long as an aluminum alloy workpiece provides one side of the workpiece stack-up and a steel workpiece provides the other side of the stack-up. As such, the workpiece stack-up may include only a steel workpiece and an overlapping aluminum alloy workpiece, or it may include two neighboring steel workpieces disposed adjacent to an aluminum alloy workpiece or two neighboring aluminum alloy workpieces disposed adjacent to a steel workpiece. Additionally, when the workpiece stack-up includes three workpieces, the two workpieces of similar composition may be provided by separate and distinct parts or, alternatively, they may be provided by the same part.

The disclosed method includes contacting opposite sides of the workpiece stack-up with opposed and facially-aligned welding electrodes at a weld site. An electrical current of sufficient magnitude and duration (constant or pulsed) is passed between the welding electrodes and through the workpiece stack-up. Passage of the electrical current creates a molten aluminum alloy weld pool within the aluminum alloy workpiece that lies adjacent to the steel workpiece. This molten aluminum alloy weld pool wets an adjacent faying surface of the steel workpiece and extends into, and possibly through, the aluminum alloy workpiece from the faying interface of the adjacent steel and aluminum alloy workpieces. During the time that the molten aluminum alloy weld pool is present, the welding electrodes indent and impress into their respective workpiece surfaces to form contact patches. Eventually, after the electrical current has ceased, the molten aluminum alloy weld pool cools and solidifies into a weld joint that bonds the adjacent steel and aluminum alloy workpieces together at their faying interface.

The spot welding method is assisted by including an intruding feature within the aluminum alloy workpiece that is contacted by a welding electrode on that particular side of the workpiece stack-up. Specifically, during spot welding, a welding electrode is pressed against a surface of the aluminum alloy workpiece over the intruding feature and current is exchanged between that electrode and the other electrode on the opposite side of the stack-up to form the weld joint. The intruding feature may be a hole that extends completely through the aluminum alloy workpiece or, alternatively, it may be a depression that only partially traverses the thickness of the aluminum alloy workpiece. And more than one intruding feature may be included in the aluminum alloy workpiece to facilitate the formation of spot welds between the two workpieces at multiple different weld sites. As for the aluminum alloy workpiece that includes the intruding feature and is contacted by the welding electrode, it may be the aluminum alloy workpiece that lies adjacent to the steel workpiece(s), as is the case in a two workpiece stack-up or a three workpiece stack-up that includes two neighboring steel workpieces, or it may be the aluminum alloy workpiece that overlies the aluminum alloy workpiece that lies adjacent to the steel workpiece, as is the case in a three workpiece stack-up that includes a steel workpiece and two neighboring aluminum alloy workpieces.

Pressing the welding electrode over the intruding feature and exchanging current through that portion of the aluminum alloy workpiece is believed to positively affect the strength of the weld joint for at least several reasons. First, the intruding feature causes the electrical current being exchanged between the welding electrodes to assume a conical flow pattern around the intruding feature within the aluminum alloy workpiece(s) at the onset of current flow and, in some instances, for the entire duration of current flow. The conical flow pattern of the electrical current results in a decrease in the current density within at least the aluminum alloy workpiece that lies adjacent to the steel workpiece—as compared to the steel workpiece—which forms three-dimensional temperature gradients around the molten aluminum alloy weld pool to help the weld pool solidify into the weld joint in a more desirable way. Second, the plastic deformation of the portion of the aluminum alloy workpiece surrounding the intruding feature is enhanced as softened or molten aluminum alloy begins to fill the intrusion. This action fractures the refractory oxide layer(s) that cover the faying surface of the aluminum alloy workpiece that lies adjacent to the steel workpiece, thus allowing the molten aluminum alloy weld pool to better wet that adjacent steel workpiece and break up the oxide residue that provides a source of near-interface defects within a growing weld pool. Such action at the faying interface between the adjacent steel and aluminum alloy workpieces is especially effective if the aluminum alloy workpiece that includes the intruding feature is also the aluminum alloy workpiece that lies adjacent to the steel workpiece.

Furthermore, if the intruding feature is present in the aluminum alloy workpiece that lies adjacent to the steel workpiece and is open at the steel workpiece, the intruding feature provides an open space or volume that allows for movement of the molten aluminum alloy weld pool during current flow, which helps break up and redistribute defects caused by oxide residue near the faying interface, thus improving the mechanical properties of the weld joint. This weld pool movement or stirring effect also occurs if the intruding feature is present in an additional aluminum alloy workpiece and the intruding feature is open to the underlying aluminum alloy workpiece that lies adjacent to the steel workpiece. This is especially true if a fully penetrating molten aluminum alloy weld pool is created within the intervening aluminum alloy workpiece that lies adjacent to the steel workpiece.

Numerous welding electrode designs can be used in conjunction with the intruding feature in the aluminum alloy workpiece, which facilitates process flexibility. Specifically, there is no need to use welding electrodes that meet stringent size and shape requirements in order to successfully spot weld workpiece stack-ups that include adjacent steel and aluminum alloy workpieces. Each of the welding electrodes can, therefore, be constructed with other purposes in mind, such as spot welding steel-to-steel or aluminum alloy-to-aluminum alloy. As such, the same welding electrodes that are typically used to spot weld an aluminum alloy workpiece to an aluminum alloy workpiece may also be used to spot weld a steel workpiece to an aluminum alloy workpiece with the help of the intruding feature, meaning that the same weld gun setup can be used to spot weld both sets of workpiece stack-ups without having to substitute either or both of the welding electrodes. The same is also true for welding electrodes that are typically used to spot weld steel-to-steel. In fact, some welding electrodes can even be used to spot-weld all three sets of stack-ups—i.e., steel-to-steel, aluminum alloy-to-aluminum alloy, and steel-to-aluminum alloy (with the intruding feature).

### BRIEF DESCRIPTION OF THE DRAWINGS

FIG. 1 is a side elevational view of a workpiece stack-up that, according to one embodiment, includes a steel workpiece and an aluminum alloy workpiece assembled in overlapping fashion for resistance spot welding at a weld site, wherein the aluminum alloy workpiece lies adjacent to the steel workpiece and includes an intruding feature;

FIG. 2 is a partial magnified cross-sectional view of the workpiece stack-up and the opposed welding electrodes depicted in FIG. 1;

FIG. 3 is a partial exploded cross-sectional side view of the workpiece stack-up and the opposed welding electrodes depicted in FIG. 2;

FIG. 4 is a cross-sectional view of an intruding feature included in the aluminum alloy workpiece according to one embodiment;

FIG. 5 is a cross-sectional view of an intruding feature included in the aluminum alloy workpiece according to another embodiment;

FIG. 6 is a cross-sectional view of an intruding feature included in the aluminum alloy workpiece according to yet another embodiment;

FIG. 7 is a cross-sectional view of an intruding feature included in the aluminum alloy workpiece according to still another embodiment;

FIG. 8 is a cross-sectional view of an intruding feature included in the aluminum alloy workpiece according to still another embodiment;

FIG. 9 is a partial cross-sectional view of a workpiece stack-up that, according to one embodiment, includes a steel workpiece and an aluminum alloy workpiece before passage of an electrical current between opposed welding electrodes, wherein a first welding electrode is contacting an exterior surface of the steel workpiece and a second welding electrode is contacting an exterior surface of the aluminum alloy workpiece;

FIG. 10 is a partial cross-sectional view of the workpiece stack-up, as depicted in FIG. 9, during spot welding in which a molten aluminum alloy weld pool has been initiated within the aluminum alloy workpiece and at the faying interface of the steel and aluminum alloy workpieces, and, additionally, a molten steel weld pool has been initiated within the steel workpiece;

FIG. 11 is a partial cross-sectional view of the workpiece stack-up of FIG. 10 after stoppage of the electrical current and retraction of the welding electrodes, wherein a weld joint has been formed at the faying interface of the steel and aluminum alloy workpieces and a steel weld nugget has been formed within the steel workpiece;

FIG. 12 is an idealized illustration showing the direction of the solidification front in a molten aluminum alloy weld pool that solidifies from the point nearest the colder welding electrode located against the aluminum alloy workpiece towards the faying interface when an intruding feature is not included in the aluminum alloy workpiece;

FIG. 13 is an idealized illustration showing the direction of the solidification front in a molten aluminum alloy weld pool when, on account of an intruding feature included in the aluminum alloy workpiece, the molten aluminum alloy weld pool solidifies from its outer perimeter towards it center;

FIG. 14 is a side elevational view of a workpiece stack-up that, according to another embodiment, includes a steel workpiece, an adjacent aluminum alloy workpiece, and a second steel workpiece assembled in overlapping fashion for resistance spot welding, wherein the aluminum alloy workpiece includes an intruding feature; and

FIG. 15 is a side elevational view of a workpiece stack-up that, according to yet another embodiment, includes a steel workpiece, an aluminum alloy workpiece, and a second aluminum alloy workpiece disposed between the steel and aluminum alloy workpieces, wherein the aluminum alloy workpiece, which makes contact with the welding electrodes but does not lie adjacent to the steel workpiece, includes an intruding feature.

### DETAILED DESCRIPTION

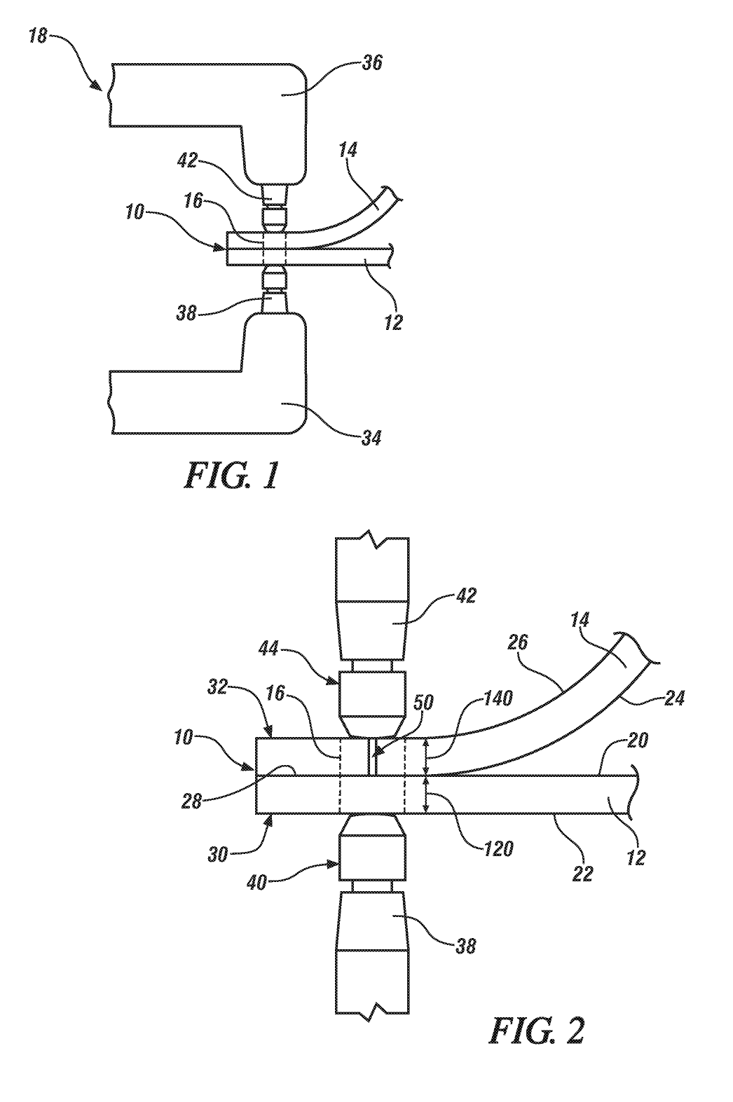

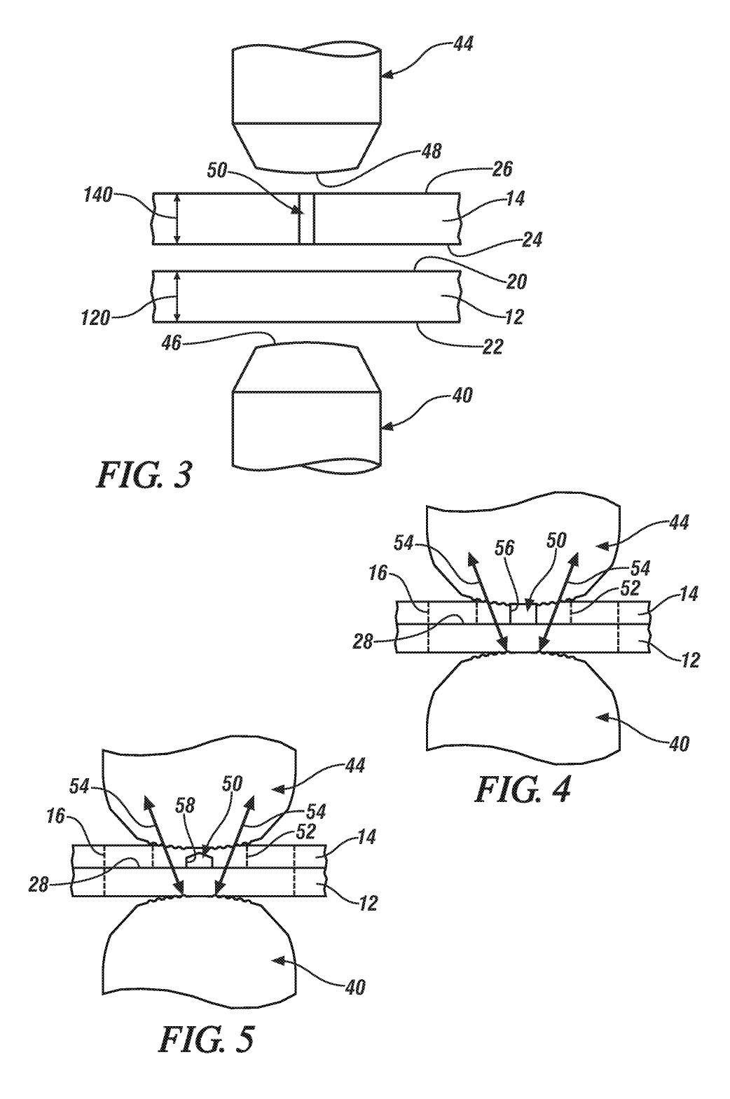

Preferred and exemplary embodiments of a method of spot welding a workpiece stack-up that includes a steel workpiece and an adjacent aluminum alloy workpiece are shown in FIGS. 1-15 and described below. The described embodiments use an intruding feature in the aluminum alloy workpiece that is contacted by a welding electrode on its side of the workpiece stack-up to affect the flow pattern and density of the electrical current that passes through the workpieces. On account of the intruding feature, which is described in further detail below, the electrical current assumes a conical flow pattern within at least the aluminum alloy workpiece that lies adjacent to the steel workpiece such that the path of current flow expands radially toward the welding electrode in contact with the aluminum alloy workpiece that includes the intruding feature (which may be the same or different from the aluminum alloy workpiece that lies adjacent to the steel workpiece). The conical flow pattern helps form a strong weld joint between the adjacent steel and aluminum alloy workpieces by creating three-dimensional temperature gradients around the molten aluminum alloy weld pool that modify the solidification behavior of the weld pool. Moreover, the intruding feature in the aluminum alloy workpiece that is contacted by the welding electrode enhances plastic deformation at the faying interface and may provide an open space or volume that allows for movement of the molten aluminum alloy weld pool during current flow, which helps further improve the strength and mechanical properties of the weld joint by breaking up and redistributing defects caused by oxide residue near the faying interface of the adjacent steel and aluminum alloy workpieces.

FIGS. 1-3 generally depict a workpiece stack-up 10 that includes a steel workpiece 12 and an aluminum alloy workpiece 14 that, in this embodiment, lie adjacent to one another. The steel workpiece 12 is preferably a galvanized (zinc-coated) low carbon steel. Other types of steel workpieces may of course be used including, for example, a low carbon bare steel or a galvanized advanced high strength steel (AHSS). Some specific types of steels that may be used in the steel workpiece 12 are interstitial-free (IF) steel, dual-phase (DP) steel, transformation-induced plasticity (TRIP) steel, and press-hardened steel (PHS). Regarding the aluminum alloy workpiece 14, it may be an aluminum-magnesium alloy, an aluminum-silicon alloy, an aluminum-magnesium-silicon alloy, or an aluminum-zinc alloy, and it may be coated with its natural refractory oxide coating or, alternatively, it may be coated with zinc, tin, or a conversion coating to improve adhesive bond performance. Some specific aluminum alloys that may be used in the aluminum alloy workpiece 14 are AA5754 aluminum-magnesium alloy, AA6111 and AA6022 aluminum-magnesium-silicon alloy, and AA7003 aluminum-zinc alloy. The term “workpiece” and its steel and aluminum variations is used broadly in the present disclosure to refer to a wrought sheet metal layer, a casting, an extrusion, or any other resistance spot weldable substrate, inclusive of any surface layers or coatings, if present.

The steel and aluminum alloy workpieces 12, 14 are assembled in overlapping fashion for resistance spot welding at a predetermined weld site 16 by a weld gun 18. When stacked-up for spot welding, the steel workpiece 12 includes a faying surface 20 and an exterior surface 22. Likewise, the aluminum alloy workpiece 14 includes a faying surface 24 and an exterior surface 26. The faying surfaces 20, 24 of the two workpieces 12, 14 overlap one another to establish a faying interface 28 at the weld site 16. The faying interface 28, as used herein, encompasses instances of direct contact between the faying surfaces 20, 24 of the workpieces 12, 14 as well as instances of indirect contact such as when the faying surfaces 20, 24 are not touching but are in close enough proximity to each another—e.g., when a thin layer of adhesive, sealer, or some other intermediate material is present—that resistance spot welding can still be practiced. A thin coating of a sealer or adhesive may be applied between the faying surfaces 20, 24 of the workpieces 12, 14 in some instances to help hold the workpieces 12, 14 together along their faying interface 28.

The exterior surfaces 22, 26 of the steel and aluminum alloy workpieces 12, 14, on the other hand, generally face away from each other in opposite directions to make them accessible by a pair of opposed spot welding electrodes. Here, in this embodiment, the exterior surface 22 of the steel workpiece 12 provides and delineates a first side 30 of the workpiece stack-up 10 and the exterior surface 26 of the aluminum alloy workpiece 14 provides and delineates a second side 32 of the workpiece stack-up 10. Each of the steel and aluminum alloy workpieces 12, 14 preferably has a thickness 120, 140—which is measured from the faying surface 20, 24 to the exterior surface 22, 26 of each workpiece 12, 14—that ranges from 0.3 mm to 6.0 mm, and more preferably from 0.5 mm to 4.0 mm, at least at the weld site 16.

The weld gun 18 used to spot weld the workpiece stack-up 10 and to join together the steel and aluminum alloy workpieces 12, 14 at their faying interface 28 may be any known type. For example, as shown here in FIGS. 1-2, the weld gun 18, which is part of a larger automated welding operation, includes a first gun arm 34 and a second gun arm 36 that are mechanically and electrically configured to repeatedly form spot welds in accordance with a defined weld schedule. The first gun arm 34 has a first electrode holder 38 that retains a first welding electrode 40, and the second gun arm 36 has a second electrode holder 42 that retains a second welding electrode 44. The first and second welding electrodes 40, 44 are each preferably formed from an electrically conductive material such as copper alloy. One specific example is a zirconium copper alloy (ZrCu) that contains 0.10 wt. % to 0.20 wt. % zirconium and the balance copper. Copper alloys that meet this constituent composition and are designated C15000 are preferred. Of course, other copper alloy compositions that possess suitable mechanical and electrical conductive properties may also be employed. The weld gun 18 depicted generally in FIGS. 1-2 is meant to be representative of a wide variety of weld guns, including c-type and x-type weld guns, as well as other weld gun types not specifically mentioned so long as they are capable of spot welding the workpiece stack-up 10.

The first welding electrode 40 includes a first weld face 46 and the second welding electrode 44 includes a second weld face 48. The weld faces 46, 48 of the first and second welding electrodes 40, 44 are the portions of the electrodes 40, 44 that, during spot welding, are pressed against and impressed into the first side 30 and the second side 32 of the workpiece stack-up 10, respectively, which in this embodiment is also the exterior surface 22 of the steel workpiece 12 and the exterior surface 26 of the aluminum alloy workpiece 14. Each of the weld faces 46, 48 may be flat or domed, and may further include surface features (e.g., surface roughness, ringed features, a plateau, etc.) as described, for example, in U.S. Pat. Nos. 6,861,609, 8,222,560, 8,274,010, 8,436,269, 8,525,066, and 8,927,894. A mechanism for cooling the electrodes 40, 44 with water is typically incorporated into the gun arms 34, 36 and the electrode holders 38, 42 to manage the temperatures of the welding electrodes 40, 44.

The weld gun arms 34, 36 are operable during spot welding to press the weld faces 46, 48 of the welding electrodes 40, 44 against the exterior surface 22 of the steel workpiece 12 and the exterior surface 26 of the aluminum alloy workpiece 14, respectively. The first and second weld faces 46, 48 are typically pressed against their respective exterior surfaces 22, 26 in facing axial alignment with one another at the intended weld site 16. An electrical current is then delivered from a controllable power source (not shown) in electrical communication with the weld gun 18. The applied electrical current is passed between the welding electrodes 40, 44. The magnitude and duration of the electrical current are set by a weld schedule programmed specifically to effectuate joining together the steel and aluminum alloy workpieces 12, 14.

Referring now specifically to FIGS. 2-4, the aluminum alloy workpiece 14 includes an intruding feature 50 that is aligned and located within the weld site 16. The intruding feature 50 may extend partially or fully between the faying and exterior surfaces 24, 26 of the aluminum alloy workpiece 14 to provide a void within the workpiece 14. When pressed against the exterior surface 26 of the aluminum alloy workpiece 14 at the start of current flow, the weld face 48 of the second welding electrode 44 makes contact with the exterior surface 26 over the intruding feature 50. In other words, if the peripheral boundary of the surface area of the exterior surface 26 contacted by the weld face 48 at the start of current flow is projected down to the faying surface 24 of the aluminum alloy workpiece 14, as illustrated here by reference numeral 52 (FIG. 4), the intruding feature 50 would be completely contained within that delineated region. This relationship between the contacted area of the exterior surface 26 and the intruding feature 50 applies whether the aluminum alloy workpiece 14 is the top or bottom workpiece in the stack-up 10. Accordingly, the term “over” should not be read to always require the aluminum alloy workpiece 14 to be on top of the steel workpiece 12 so that, strictly speaking, the second welding electrode 44 is above the intruding feature 50.

The intruding feature 50 causes the electrical current being exchanged between the welding electrodes 40, 44 to assume a conical flow pattern within the aluminum alloy workpiece 14 around the intruding feature 50 at least at the onset of current flow, as represented by arrows 54 (FIG. 4). The conical electrical current flow pattern 54 induced by the intruding feature 50 expands radially from the faying interface 28 towards the second welding electrode 44. It also has an annular cross-section at the interface of the weld face 48 of the second welding electrode 44 and the exterior surface 26 of aluminum alloy workpiece 14. By inducing the conical flow pattern 54, and thus decreasing the current density in the aluminum alloy workpiece 14 directionally from the faying interface 28 towards the second welding electrode 44, heat is concentrated within a smaller zone in the steel workpiece 12 as compared to the aluminum alloy workpiece 14. As will be further explained below, the act of concentrating heat within a smaller zone in the steel workpiece 12 creates three-dimensional temperature gradients—in particular radial temperature gradients acting in the plane of both workpieces 12, 14—that change the solidification behavior of the molten aluminum alloy weld pool initiated and grown at the faying interface 28 so that defects in the ultimately-formed weld joint are directed to a more innocuous location.

In addition to changing the current flow through the aluminum alloy workpiece 14, the intruding feature 50 helps minimize the adverse effects of the surface oxide layer(s) that may be present on the faying surface 24 of the aluminum alloy workpiece 14 at the weld site 16. The belief here is that the portion of the aluminum alloy workpiece 14 in the immediate surrounding vicinity of the intruding feature 50 is plastically deformed more easily by the pressure imparted by the second welding electrode 44. Such enhanced plastic deformation fractures and breaks up the refractory oxide layer(s) covering the faying surface 24 of the aluminum alloy workpiece 14, which allows the molten aluminum alloy weld pool to better wet the adjacent faying surface 20 of the steel workpiece 12, and additionally breaks up the refractory oxide residue that becomes incorporated into the molten aluminum alloy weld pool and provides a source of near-interface defects within the growing weld pool.

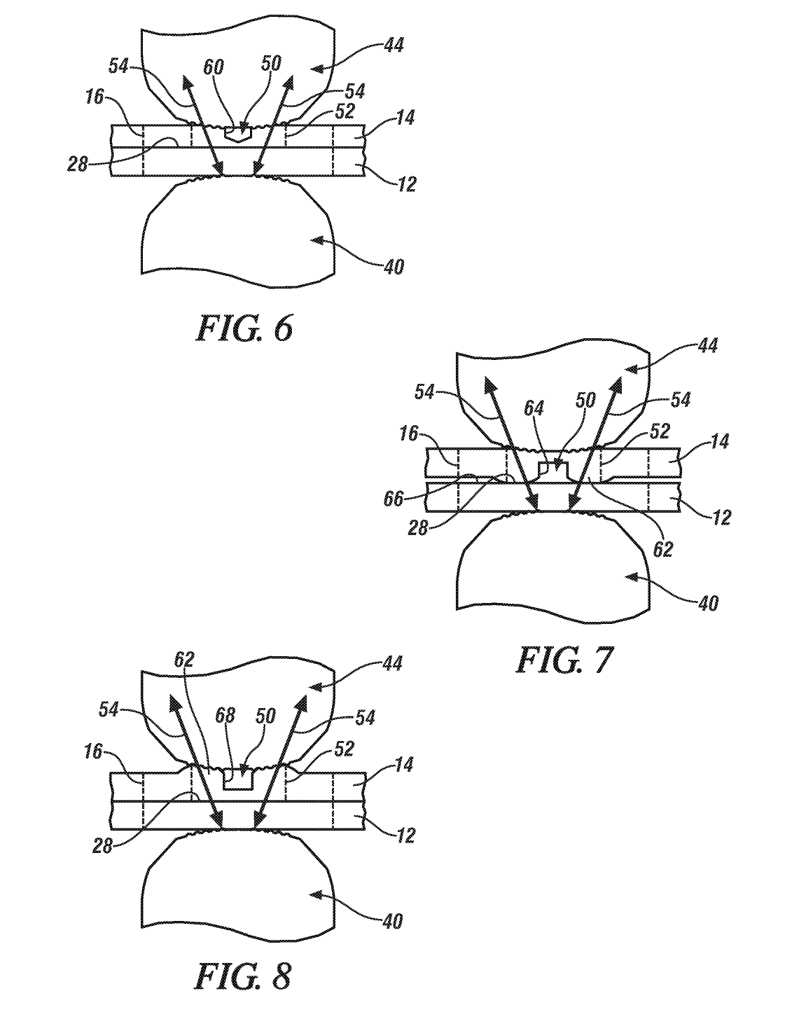

The intruding feature 50 may be constructed in numerous ways. In one specific embodiment, as shown in FIG. 4, the intruding feature 50 may be a through hole 56 that extends between the faying and exterior surfaces 24, 26 of the aluminum alloy workpiece 14 to entirely traverse the thickness 140 of the workpiece 14. The intruding feature 50, however, does not necessarily have to extend all the way through the workpiece 14 in that way. For example, in another embodiment, as shown in FIG. 5, the intruding feature 50 may be a depression 58 that partially traverses the thickness 140 of the aluminum alloy workpiece 14, extending from the faying surface 24 of the workpiece 14 but not reaching the exterior surface 26. Similarly, in another embodiment, as shown in FIG. 6, the intruding feature 50 may be a depression 60 that partially traverses the thickness 140 of the aluminum alloy workpiece 14, this time extending from the exterior surface 26 of the workpiece 14 but not reaching the faying surface 24. The intruding features 50 shown in FIGS. 5-6 are helpful in keeping sealants or adhesives that are sometimes applied between the workpieces 12, 14 at the weld site 16 from contacting the weld face 48 of the second welding electrode 44.

Furthermore, as shown in FIGS. 7-8, the intruding feature 50 may be combined with a raised ring 62 that preferably continuously surrounds the intruding feature 50. The raised ring 62 may be a consequence of the forming operation used to make the intruding feature 50 such as, for example, embossing or the use of a punch and die. As shown in FIG. 7, the intruding feature 50 may be a depression 64 that partially traverses the thickness 140 of the aluminum alloy workpiece 14, extending from the faying surface 24 of the workpiece 14 but not reaching the exterior surface 26, and the raised ring 62 may establish the faying interface 28 with the steel workpiece 12. Because the raised ring 62 protrudes above the faying surface 24 of the aluminum alloy workpiece 14 at the weld site 16, the faying surface 24 of the aluminum alloy workpiece 14 that surrounds the raised ring 62 is separated from the faying surface 20 of the steel workpiece 12 at the beginning of current flow by a gap 66. In another embodiment, which is shown in FIG. 8, the intruding feature 50 may be a depression 68 that partially traverses the thickness 140 of the aluminum alloy workpiece 14, this time extending from the exterior surface 26 of the workpiece 14 but not reaching the faying surface 24. The raised ring 62 employed here makes contact with the weld face 48 of the second welding electrode 44 during spot welding. The raised ring 62 may also be used with a through hole, like the one depicted in FIG. 1, as well as other intruding feature constructions, despite not being expressly shown in the drawings.

Regardless of its exact construction, the intruding feature 50 is preferably dimensioned according to certain metrics in order to ensure that it materially affects electrical current flow between the first and second welding electrodes 40, 44. For instance, the intruding feature 50 preferably has a diameter that is greater than the thickness 140 of the aluminum alloy workpiece 14 at the weld site 16. Under such circumstances, the minimum diameter of the intruding feature 50 may range from 2 mm to 8 mm and, more narrowly, from 3 mm to 6 mm, depending on the thickness 140 of the aluminum alloy workpiece 14. Additionally, the internal volume of the intruding feature 50 is preferably great enough to disrupt the refractory oxide layer(s) that may be present at the faying interface 28. Providing the internal feature 50 with an internal volume of greater than 2 mm³, and more preferably greater than 6 mm³, is sufficient for this purpose.

The intruding features 50 shown in FIGS. 4-5 and 7 (features 56, 58, and 64) are examples features that are open to the faying surface 20 of the steel workpiece 12. Under such circumstances, the intruding features 50 in FIGS. 4-5 and 7, as well as other intruding features that are similarly open but not expressly shown here, provide an open space or volume that allows for movement of the molten aluminum alloy weld pool during its initiation and growth within the aluminum alloy workpiece 14. This type of movement or stirring of the molten aluminum alloy weld pool can improve the mechanical properties of the weld joint by breaking up and redistributing oxide residue defects that are oftentimes found near the faying interface 28.

FIGS. 1-2 and 9-11 illustrate one embodiment of a spot welding process in which the workpiece stack-up 10 is spot-welded at the weld site 16 to join together the adjacent steel and aluminum alloy workpieces 12, 14 with the assistance of the intruding feature 50 contained in the aluminum alloy workpiece 14. To begin, the workpiece stack-up 10 is located between the first and second welding electrodes 40, 44 so that the opposed weld faces 46, 48 are facially aligned at the weld site 16. The workpiece stack-up 10 may be brought to such a location, as is often the case when the gun arms 34, 36 are part of a stationary pedestal welder, or the gun arms 34, 36 may be robotically moved to locate the welding electrodes 40, 44 relative to the weld site 16.

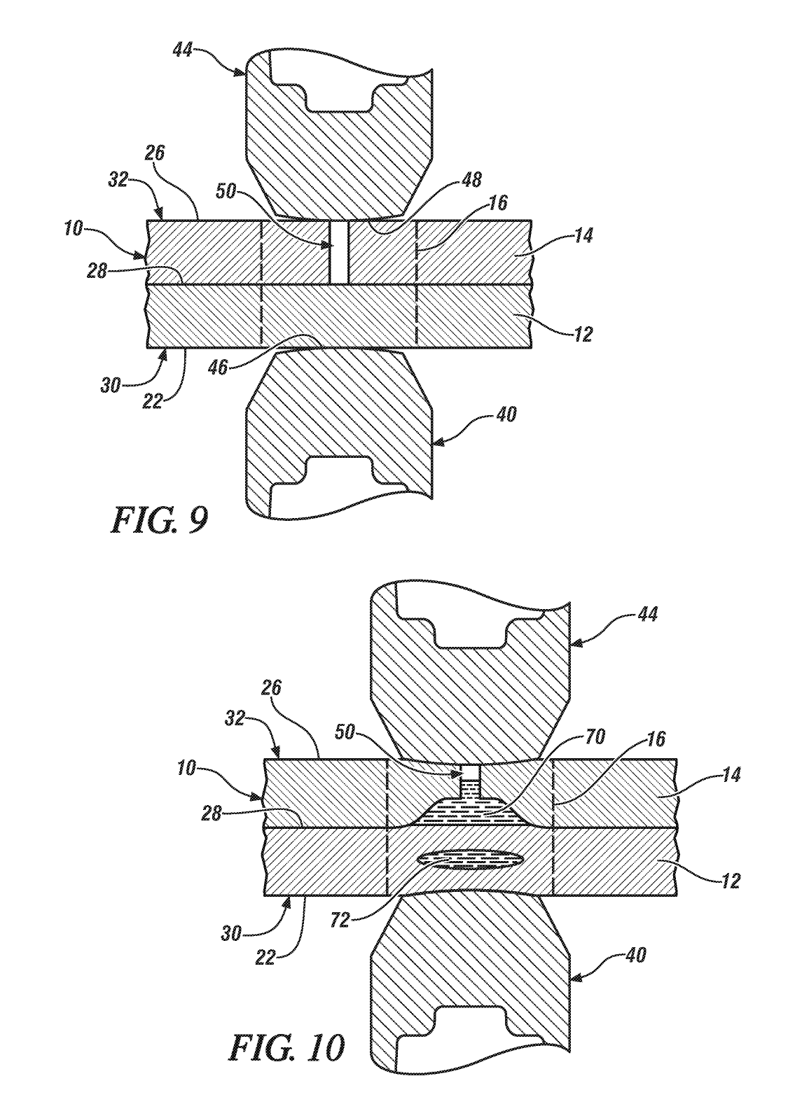

Once the workpiece stack-up 10 is properly located, the first and second gun arms 34, 36 converge relative to one another to contact and press the weld faces 46, 48 of the first and second welding electrodes 40, 44 against the opposed first and second sides 30, 32 of the workpiece stack-up 10, as shown in FIG. 9. Here, in this embodiment, the weld face 46 of the first welding electrode 40 is pressed against the exterior surface 22 of the steel workpiece 12 and the weld face 48 of the second welding electrode 44 is pressed against the oppositely-facing exterior surface 26 of the aluminum alloy workpiece 14 over the intruding feature 50. The clamping force assessed by the gun arms 34, 36 helps establish good mechanical and electrical contact between the welding electrodes 40, 44 and the exterior surfaces 22, 26 they engage. It also helps breakdown the surface oxide layer(s) that may be present on the faying surface 24 of the aluminum alloy workpiece 14 by plastically deforming the portion of the workpiece 14 around the intruding feature 50.

An electrical current—typically a DC current between about 5 kA and about 50 kA—is then passed between the weld faces 46, 48 and through the workpiece stack-up 10 at the weld site 16 as prescribed by the weld schedule. The electrical current is typically passed as a constant current or a series of current pulses over a period of 40 milliseconds to 1000 milliseconds. At least at the beginning of current flow, the intruding feature 50 causes the current to assume the conical flow pattern 54 (FIGS. 4-8) within the aluminum alloy workpiece 14. The conical flow pattern 54 develops because the intruding feature 50 provides an electrically insulating void within the aluminum alloy workpiece 14 between the weld faces 46, 48 of the facially aligned first and second welding electrodes 40, 44. The presence of such an electrically insulating void forces the electrical current to expand radially from the faying interface 28 towards the second welding electrode 44 and, additionally, to define an annular cross-section at the interface of the weld face 48 of the second welding electrode 44 and the exterior surface 26 of aluminum alloy workpiece 14 where the electrical current is most concentrated, as previously described. The first welding electrode 40, on the other hand, passes the electrical current through a more concentrated sectional area within the steel workpiece 12.

The passage of the electrical current between the welding electrodes 40, 44 and through the workpiece stack-up 10 causes the steel workpiece 12 to initially heat up more quickly than the aluminum alloy workpiece 14 since it has higher thermal and electrical resistivities. The heat generated from the resistance to the flow of electrical current across the faying interface 28—in conjunction with the heat that flows from the steel workpiece 12 into the aluminum alloy workpiece 14—eventually melts the aluminum alloy workpiece 14 at the weld site 16 and initiates a molten aluminum alloy weld pool 70, as depicted in FIG. 10. The continued passing of the electrical current through the workpieces 12, 14 ultimately grows the molten aluminum alloy weld pool 70 to the desired size which, in many instances, results in the weld pool 70 fully penetrating through the entire thickness 140 of the aluminum alloy workpiece 14. During this time, the molten aluminum alloy weld pool 70 wets an adjacent area of the faying surface 20 of the steel workpiece 12. The molten aluminum alloy weld pool 70 may fill, at least partially and oftentimes fully, the intruding feature 50.

The inducement of the conical electrical current flow pattern 54 within the aluminum alloy workpiece 14 results in heat being concentrated within a smaller zone in the steel workpiece 12 as compared to the aluminum alloy workpiece 14. Because heat is less concentrated in the aluminum alloy workpiece 14, less damage is done to the surrounding portions of the aluminum alloy workpiece 14 outside of the weld site 16. As such, the weld schedule can be set, if desired, to initiate and grow a molten steel weld pool 72 within the confines of the steel workpiece 12 in addition to initiating and growing the molten aluminum alloy weld pool 70 within the aluminum alloy workpiece 14 and at the faying interface 28. FIG. 10 illustrates the presence of both the molten aluminum alloy weld pool 70 and the molten steel weld pool 72. The heat generated by the electrical current, however, does not always have to be so concentrated in the steel workpiece 12 that the molten steel weld pool 68 is created.

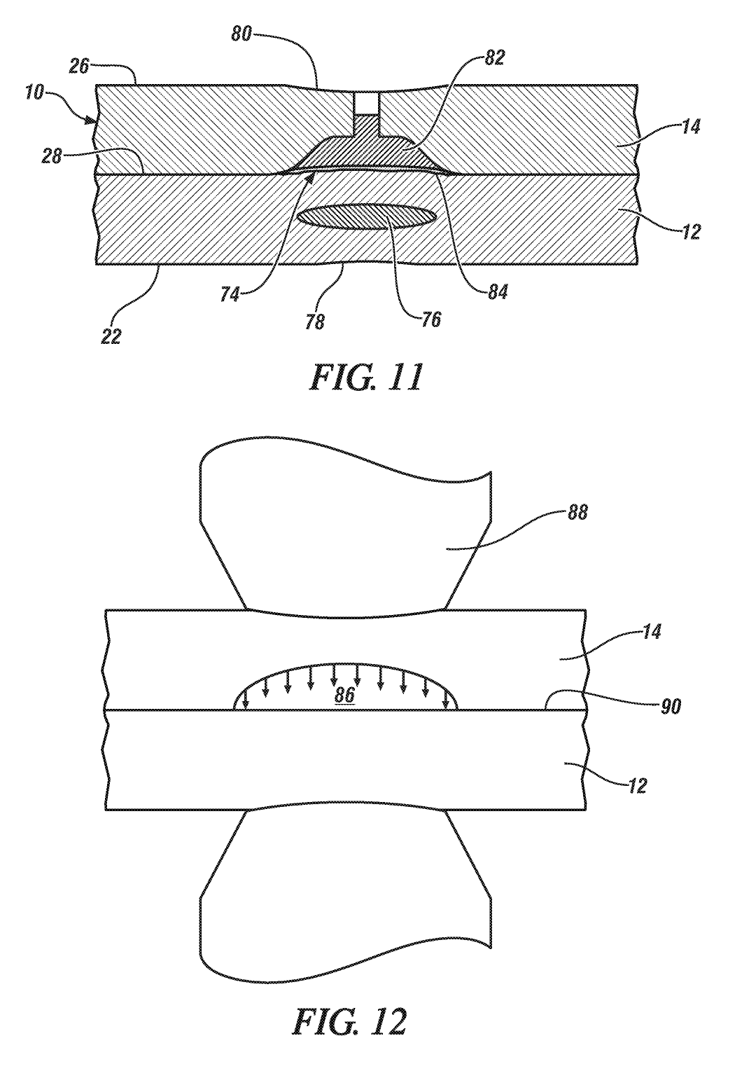

Upon cessation of the electrical current flow, the molten aluminum alloy weld pool 70 solidifies to form a weld joint 74 that bonds the steel and aluminum alloy workpieces 12, 14 together at the faying interface 28, as illustrated generally in FIG. 11. The molten steel weld pool 72, if formed, likewise solidifies at this time into a steel weld nugget 76 within the steel workpiece 12, although it preferably does not extend to either the faying surface 20 or the exterior surface 22 of that workpiece 12. The welding electrodes 40, 44 are eventually retracted from the weld site 16 and re-positioned at another weld site to conduct a similar spot welding process. Retraction of the first and second welding electrodes 40, 44 leaves behind an impressed contact patch 78 on the exterior surface 22 of the steel workpiece 12 and an impressed contact patch 80 on the exterior surface 26 of the aluminum alloy workpiece 14. The contact patch 80 on the aluminum alloy workpiece 14 is usually larger in surface area than the contact patch 78 on the steel workpiece 12.

The weld joint 74 includes an aluminum alloy weld nugget 82 and, typically, one or more reaction layers 84 of Fe—Al intermetallic compounds. The aluminum alloy weld nugget 82 penetrates into the aluminum alloy workpiece 14 to a distance that exceeds 20% of the thickness 140 of the aluminum alloy workpiece 14, oftentimes fully penetrating through the entire thickness 140 (i.e., 100%) of the workpiece 14. The one or more reaction layers 84 of Fe—Al intermetallic compounds, if present, are situated between the bulk of the aluminum alloy weld nugget 82 and the steel workpiece 12. These layers are produced mainly as a result of reaction between the molten aluminum alloy weld pool 70 and the steel workpiece 12 at spot welding temperatures during current flow and for a short period of time after current flow when the steel workpiece 12 is still hot. The one or more layers 84 of Fe—Al intermetallic compounds can include intermetallics such as FeAl₃ and Fe₂Al₅, as well as others, and their combined thickness typically ranges from 1 μm to 3 μm, when measured in the same direction as the thicknesses 120, 140 of the workpieces 12, 14, in at least the portion of the weld joint 74 underneath where the intruding feature 50 was present. A total intermetallic reaction layer(s) thickness of 1 μm to 3 μm at this location is thinner than what would normally be expected if the intruding feature 50 is not used.

As alluded to above, the inducement of the conical electrical current flow pattern 54 within the aluminum alloy workpiece 14 is believed to alter the solidification behavior of the molten aluminum alloy weld pool 70 so as to improve the strength and integrity of the weld joint 74 in at least one of two ways, in addition to the other beneficial attributes associated with the intruding feature 50. First, the more concentrated heat zone within the steel workpiece 12 changes the temperature distribution through the weld site 16 by creating three-dimensional radial temperature gradients within the plane of the steel workpiece 12 that are reflected in the plane of the aluminum alloy workpiece 14. The expanded radial temperature gradients, in turn, help disseminate heat laterally through the workpieces 12, 14, which causes the molten aluminum alloy weld pool 70 to solidify from its outer perimeter towards its center as opposed to directionally towards the faying interface 28. This solidification behavior sweeps or drives weld defects away from the nugget perimeter and toward the center of the weld joint 74 where they are less prone to weaken the joint 74 and interfere with its structural integrity.

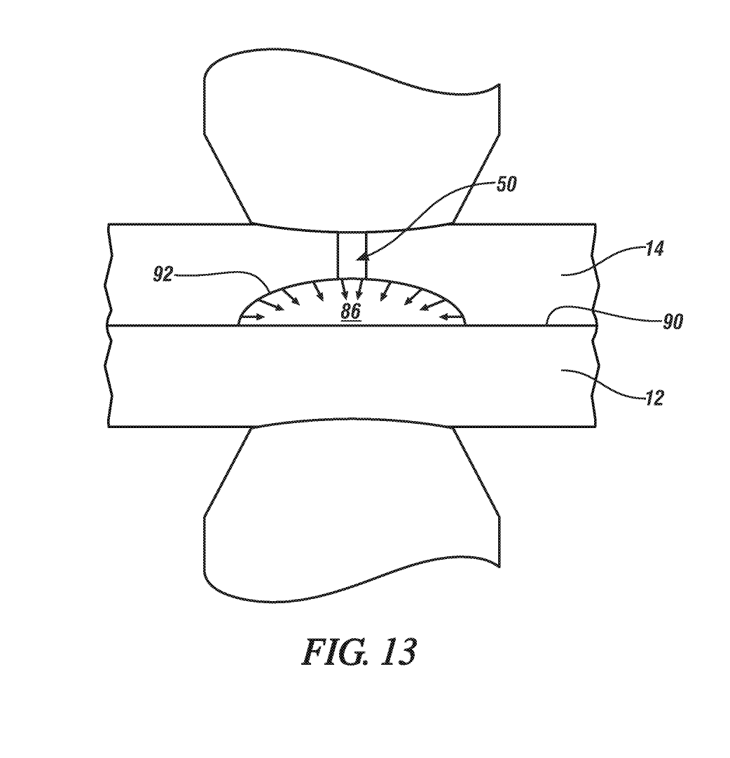

FIGS. 12-13 help visualize the solidification behavior thought to occur as a result of the intruding feature 50 being present in the aluminum alloy workpiece 14. In FIG. 12, where no intruding feature is present in the aluminum alloy workpiece 14, a molten aluminum alloy weld pool 86 solidifies from the point nearest the colder welding electrode 88 located against the aluminum alloy workpiece 14 towards the faying interface 90, which, consequently, drives weld defects towards and along the faying interface 90. In contrast, in FIG. 13, where an intruding feature 50 is present in the aluminum alloy workpiece 14, the molten aluminum alloy weld pool 86 solidifies from its outer perimeter 92 towards its center, which drives weld defects to conglomerate more in the center of the ultimately-formed weld joint and limits their dispersal at and along the faying interface 90, leading to a stronger weld joint.

Second, in instances where the molten steel weld pool 72 is initiated and grown, the faying surface 20 of the steel workpiece 12 tends to distort away from the exterior surface 22. Such distortion can cause the steel workpiece 12 to thicken at the weld site 16 by as much as 50%. Increasing the thickness 120 of the steel workpiece 12 in this way helps maintain an elevated temperature at the center of the molten aluminum alloy weld pool 70—allowing that area of the weld pool 70 to cool and solidify last—which can further increase radial temperature gradients and drive weld defects towards the center of the weld joint 74. The swelling of the faying surface 20 of the steel workpiece 12 can also inhibit or disrupt formation of the one or more reaction layers 84 of Fe—Al intermetallic compounds that tend to form at the interface of the molten aluminum alloy weld pool 70 and the faying surface 20 of the steel workpiece 12. Still further, once the weld joint 74 is in service, the swelling of the faying surface 20 of the steel workpiece 12 can interfere with crack propagation around the weld joint 74 by deflecting cracks along a non-preferred path.

The embodiments described above and shown in FIGS. 1-13 are directed to instances in which the workpiece stack-up 10 includes one steel workpiece 12, which includes an exterior surface 22 that provides and delineates the first side 30 of the stack-up 10, and one aluminum alloy workpiece 14 that lies adjacent to the steel workpiece 12 and includes an exterior surface 26 that provides and delineates an opposed second side 32 of the stack-up 10. In other instances, however, a workpiece stack-up may include two steel workpieces (and one aluminum alloy workpiece) or two aluminum alloy workpiece (and one steel workpiece) so long as an aluminum alloy workpiece provides and delineates one side of the workpiece stack-up 10 and a steel workpiece provides and delineates the opposed other side of the stack-up 10. When the intruding feature 50 is included in an aluminum alloy workpiece that is part of a three-workpiece stack-up, and the aluminum alloy workpiece with the intruding feature 50 is arranged within the stack-up so that, during spot welding, a welding electrode makes contact with that workpiece over the intruding feature 50 as described above, the intruding feature 50 functions in generally the same manner and has the same general effect on a weld joint formed between the adjacent steel and aluminum alloy workpieces as previously described.

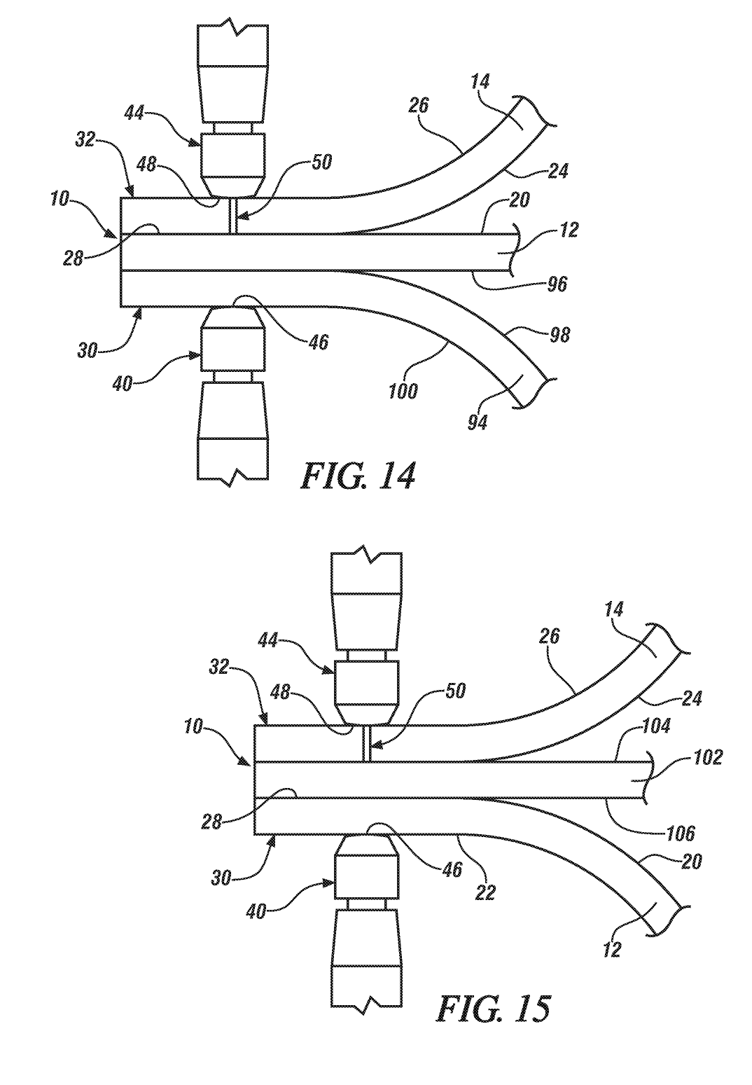

As shown in FIG. 14, for example, the workpiece stack-up 10 may include the steel and aluminum alloy workpieces 12, 14 described above in addition to a second steel workpiece 94. Here, as shown, the second steel workpiece 94 overlaps the adjacent steel and aluminum alloy workpieces 12, 14 and is positioned next to the steel workpiece 12. When the second steel workpiece 94 is so positioned, the exterior surface 26 of the aluminum alloy workpiece 14 provides and delineates the second side 32 of the workpiece stack-up 10, as before, while the steel workpiece 12 that lies adjacent to the aluminum alloy workpiece 14 now includes a pair of opposed faying surfaces 20, 96. The faying surface 20 of the steel workpiece 12 that confronts and contacts the adjacent faying surface 24 of the aluminum alloy workpiece 14 establishes the faying interface 28 between the two workpieces 12, 14. The faying surface 96 of the steel workpiece 12 that faces in the opposite direction confronts and makes overlapping contact with a faying surface 98 of the second steel workpiece 94. As such, in this particular arrangement of lapped workpieces 12, 14, 94, an exterior surface 100 of the second steel workpiece 94 now provides and delineates the first side 30 of the workpiece stack-up 10.

In another example, as shown in FIG. 15, the workpiece stack-up 10 may include the steel and aluminum alloy workpieces 12, 14 described above in addition to a second aluminum alloy workpiece 102. Here, as shown, the second aluminum alloy workpiece 102 is disposed in overlapping fashion between the steel and aluminum alloy workpieces 12, 14 and, thus, includes a pair of opposed faying surfaces 104, 106. And when the second aluminum alloy workpiece 102 is so positioned, the exterior surface 22 of the steel workpiece 12 still provides and delineates the first side 30 of the workpiece stack-up 10 and the exterior surface 26 of the aluminum alloy workpiece 14 still provides and delineates the second side 32 of the workpiece stack-up 10. In this embodiment, however, the faying surface 106 of the second aluminum alloy workpiece 102 confronts and contacts the adjacent faying surface 20 of the steel workpiece 12 to establish the faying interface 28 at the weld site 16 where the two workpieces 12, 102 are to be joined together by a weld joint. The other faying surface 104 of the second aluminum alloy workpiece 102 confronts and makes overlapping contact with the faying surface 24 of the aluminum alloy workpiece 14 that provides and delineates the second side 32 of the workpiece stack-up 10.

The intruding feature 50 included within the aluminum alloy workpiece 14 that provides and delineates the second side 32 of the workpiece stack-up 10 can be used to help spot weld the workpiece stack-ups 10 depicted in each of FIGS. 14 and 15 and to enhance the strength of a weld joint formed between the steel workpiece 12 and the adjacent aluminum alloy workpiece 14, 102 contained within the stack-ups 10 in the same general way as before. Specifically, after the stack-up 10 is assembled, the weld face 46 of the first welding electrode 40 is pressed against the first side 30 of the workpiece stack-up 10, which may be the exterior surface 22 of the steel workpiece 12 (FIG. 15) or the exterior surface 100 of the second steel workpiece 94 (FIG. 14), and the weld face 48 of the second welding electrode 44 is pressed against the second side 32 of the workpiece stack-up 10, which is the exterior surface 26 of the aluminum alloy workpiece 14 (FIGS. 14 and 15) that may or may not lie adjacent to the steel workpiece 12. An electrical current is then exchanged between the axially and facially aligned weld faces 46, 48 of the welding electrodes 40, 44 to form a weld joint that bonds the adjacent steel and aluminum alloy workpieces 12 and 14, 102 together.

In each of the embodiments depicted in FIGS. 14 and 15, the presence of the intruding feature 50 in the aluminum alloy workpiece 14 that provides and delineates the second side 32 of the workpiece stack-up 10, and is thus contacted by the weld face 48 of the second welding electrode 44, induces the conical electrical current flow pattern 54 within at least the aluminum alloy workpiece 14, 102 that lies adjacent to the steel workpiece 12. The conical electrical current flow pattern 54, in turn, helps the molten aluminum alloy weld pool created within the aluminum alloy workpiece 14, 102 by the electrical current solidify into the weld joint in a more desirable way. The presence of the intruding feature 50 in the aluminum alloy workpiece 14 that is contacted by the weld face 48 of the second welding electrode 44 also promotes plastic deformation within the aluminum alloy workpiece 14 and the disruption and break up of and refractory oxide layer(s) at the faying interface 28 of the adjacent steel and aluminum alloy workpieces 12 and 14, 102 and, in some instances, provides an open space or volume that allows for movement of the molten aluminum alloy weld pool during current flow. Each of these actions helps minimize the adverse effects that often result from the refractory oxide layer(s) present on the faying surface 24, 106 of the aluminum alloy workpiece 14, 102 that lies adjacent to the steel workpiece 12.

The above description of preferred exemplary embodiments and specific examples are merely descriptive in nature; they are not intended to limit the scope of the claims that follow. Each of the terms used in the appended claims should be given its ordinary and customary meaning unless specifically and unambiguously stated otherwise in the specification.

1. A method of spot welding a workpiece stack-up that includes a steel workpiece and an adjacent aluminum alloy workpiece, the method comprising:
providing a workpiece stack-up having a first side and an opposed second side, the workpiece stack-up comprising an aluminum alloy workpiece having an exterior surface that provides and delineates the second side of the workpiece stack-up, and further comprising a steel workpiece that overlaps, contacts, and establishes a faying interface with either a faying surface of the aluminum alloy workpiece that provides and delineates the second side of the workpiece stack-up or a faying surface of a second aluminum alloy workpiece within the workpiece stack-up, and wherein the aluminum alloy workpiece that provides and delineates the second side of the workpiece stack-up includes an intruding feature;
pressing a first weld face of a first welding electrode against the first side of the workpiece stack-up and pressing a second weld face of a second welding electrode against the exterior surface of the aluminum alloy workpiece that provides and delineates the second side of the workpiece stack-up, the first and second weld faces of the first and second welding electrodes being facially aligned at a weld site, and the second weld face of the second welding electrode being pressed against the exterior surface of the aluminum alloy workpiece that provides and delineates the second side of the workpiece stack-up over the intruding feature; and
passing an electrical current between the first and second welding electrodes and through the workpiece stack-up at the weld site to create a molten aluminum alloy weld pool that wets an adjacent faying surface of the steel workpiece, and wherein the molten aluminum alloy weld pool solidifies into a weld joint that bonds the steel workpiece to either the aluminum alloy workpiece that provides and delineates the second side of the workpiece stack-up or the second aluminum alloy workpiece within the workpiece stack-up, whichever establishes the faying interface with the steel workpiece, upon ceasing passage of the electrical current through the workpiece stack-up.

2. The method set forth in claim 1, wherein the steel workpiece has an exterior surface that provides and delineates the first side of the workpiece stack-up, and wherein the aluminum alloy workpiece that provides and delineates the second side of the workpiece stack-up further includes a faying surface that overlaps, contacts, and establishes the faying interface with the faying surface of the steel workpiece.

3. The method set forth in claim 1, wherein the aluminum alloy workpiece that provides and delineates the second side of the workpiece stack-up further includes a faying surface that overlaps, contacts, and establishes the faying interface with the faying surface of the steel workpiece, and wherein the workpiece stack-up further comprises a second steel workpiece that overlaps and is positioned next to the steel workpiece that establishes the faying interface with the aluminum alloy workpiece, the second steel workpiece having an exterior surface that provides and delineates the first side of the workpiece stack-up.

4. The method set forth in claim 1, wherein the workpiece stack-up comprises the aluminum alloy workpiece that provides and delineates the second side of the workpiece stack-up and a second aluminum alloy workpiece, the second aluminum alloy workpiece having a faying surface that overlaps, contacts, and establishes the faying interface with the faying surface of the steel workpiece, and wherein the steel workpiece further has an exterior surface that provides and delineates the first side of the workpiece stack-up.

5. The method set forth in claim 1, wherein the intruding feature is a through hole that extends entirely through the aluminum alloy workpiece that provides and delineates the second side of the workpiece stack-up.

6. The method set forth in claim 1, wherein the intruding feature is a depression that partially traverses a thickness of the aluminum alloy workpiece that provides and delineates the second side of the workpiece stack-up.

7. The method set forth in claim 1, wherein the weld joint, which bonds the steel workpiece to either the aluminum alloy workpiece that provides and delineates the second side of the workpiece stack-up or the second aluminum alloy workpiece within the workpiece stack-up, comprises an aluminum alloy weld nugget and one or more reaction layers of intermetallic compounds between the aluminum alloy weld nugget and the adjacent steel workpiece.

8. The method set forth in claim 1, wherein the step of passing electrical current between the first and second welding electrodes further comprises:
creating a molten steel weld pool within the steel workpiece, the molten steel weld pool causing a thickness of the steel workpiece to increase by up to 50% at the weld site, and wherein the molten steel weld pool solidifies into a steel weld nugget upon ceasing passage of the electrical current through the workpiece stack-up.

9. A method of spot welding a workpiece stack-up that includes a steel workpiece and an adjacent aluminum alloy workpiece, the method comprising:
providing a workpiece stack-up having a first side and an opposed second side, the workpiece stack-up comprising an aluminum alloy workpiece having an exterior surface that provides and delineates the second side of the workpiece stack-up, and further comprising a steel workpiece having a faying surface that overlaps and contacts a faying surface of the aluminum alloy workpiece to establish a faying interface between the two workpieces, and wherein the aluminum alloy workpiece that provides and delineates the second side of the workpiece stack-up includes an intruding feature;
pressing a first weld face of a first welding electrode against the first side of the workpiece stack-up and pressing a second weld face of a second welding electrode against the second side of the workpiece stack-up such that the first and second weld faces of the first and second welding electrodes are facially aligned at a weld site, the second weld face of the second welding electrode being pressed against the exterior surface of the aluminum alloy workpiece over the intruding feature; and
passing an electrical current between the first and second welding electrodes and through the workpiece stack-up at the weld site to create a molten aluminum alloy weld pool within the aluminum alloy workpiece that wets the adjacent faying surface of the steel workpiece at the faying interface established between the two workpieces, and wherein the molten aluminum alloy weld pool solidifies into a weld joint that bonds the steel workpiece and the aluminum alloy workpiece together at their faying interface upon ceasing passage of the electrical current through the workpiece stack-up.

10. The method set forth in claim 9, wherein the steel workpiece has an exterior surface that provides and delineates the first side of the workpiece stack-up.

11. The method set forth in claim 9, wherein the workpiece stack-up further comprises a second steel workpiece that overlaps, contacts, and is positioned next to the steel workpiece that establishes the faying interface with the aluminum alloy workpiece, the second steel workpiece having an exterior surface that provides and delineates the first side of the workpiece stack-up.

12. The method set forth in claim 9, wherein the step of passing electrical current between the first and second welding electrodes further comprises:
creating a molten steel weld pool within the steel workpiece, the molten steel weld pool causing a thickness of the steel workpiece to increase by up to 50% at the weld site, and wherein the molten steel weld pool solidifies into a steel weld nugget upon ceasing passage of the electrical current through the workpiece stack-up.

13. The method set forth in claim 9, wherein the weld joint, which bonds the steel workpiece and the aluminum alloy workpiece together, comprises an aluminum alloy weld nugget and one or more reaction layers of intermetallic compounds between the aluminum alloy weld nugget and the adjacent steel workpiece.

14. The method set forth in claim 9, wherein the intruding feature is a through hole that extends entirely through the aluminum alloy workpiece.

15. The method set forth in claim 9, wherein the intruding feature is a depression that partially traverses a thickness of the aluminum alloy workpiece.

16. A method of spot welding a workpiece stack-up that includes a steel workpiece and an adjacent aluminum alloy workpiece, the method comprising:
providing a workpiece stack-up having a first side and an opposed second side, the workpiece stack-up comprising an aluminum alloy workpiece having an exterior surface that provides and delineates the second side of the workpiece stack-up, a steel workpiece having an exterior surface that provides and delineates the second side of the workpiece stack-up, and a second aluminum alloy workpiece disposed between the steel workpiece and the aluminum alloy workpiece that provides and delineates the second side of the workpiece stack-up, the second aluminum alloy workpiece having a faying surface that overlaps and contacts a faying surface of the steel workpiece to establish a faying interface between the two workpieces, and wherein the aluminum alloy workpiece that provides and delineates the second side of the workpiece stack-up includes an intruding feature;
pressing a first weld face of a first welding electrode against the first side of the workpiece stack-up and pressing a second weld face of a second welding electrode against the second side of the workpiece stack-up such that the first and second weld faces of the first and second welding electrodes are facially aligned at a weld site, the first weld face of the first welding electrode being pressed against the exterior surface of the steel workpiece and the second weld face of the second welding electrode being pressed against the exterior surface of the aluminum alloy workpiece over the intruding feature; and
passing an electrical current between the first and second welding electrodes and through the workpiece stack-up at the weld site to create a molten aluminum alloy weld pool within the second aluminum alloy workpiece that wets the adjacent faying surface of the steel workpiece at the faying interface established between the two workpieces, and wherein the molten aluminum alloy weld pool solidifies into a weld joint that bonds the steel workpiece and the second aluminum alloy workpiece together at their faying interface upon ceasing passage of the electrical current through the workpiece stack-up.

17. The method set forth in claim 16, wherein the step of passing electrical current between the first and second welding electrodes further comprises:
creating a molten steel weld pool within the steel workpiece, the molten steel weld pool causing a thickness of the steel workpiece to increase by up to 50% at the weld site, and wherein the molten steel weld pool solidifies into a steel weld nugget upon ceasing passage of the electrical current through the workpiece stack-up.

18. The method set forth in claim 16, wherein the weld joint, which bonds the steel workpiece and the second aluminum alloy workpiece together, comprises an aluminum alloy weld nugget and one or more reaction layers of intermetallic compounds between the aluminum alloy weld nugget and the adjacent steel workpiece.

19. The method set forth in claim 16, wherein the intruding feature is a through hole that extends entirely through the aluminum alloy workpiece.

20. The method set forth in claim 16, wherein the intruding feature is a depression that partially traverses a thickness of the aluminum alloy workpiece.
